(19) United States
(12) Patent Application Publication
(10) Pub. No.: US 2026/0208146 A1
(43) Pub. Date: Jul. 23, 2026

(54) REACTION ZONE FOR A FLUID PROCESSING TURBOHEATING MACHINE

(71) Applicant: Siemens Energy Global GmbH & Co. KG, München (DE)

(72) Inventors: William C. Maier, Almond, NY (US); Ravichandra Srinivasan, Renton, WA (US)

(21) Appl. No.: 19/144,547

(22) PCT Filed: Jan. 22, 2024
(86) PCT No.: PCT/US2024/012417

§ 371 Date: Jun. 30, 2025

Related U.S. Application Data
(60) Provisional application No. 63/440,564, filed on Jan. 23, 2023.

(51) Int. Cl. B01J 19/18; B01J 3/08; B01J 19/00

(52) U.S. Cl. CPC B01J 19/1806; B01J 3/08; B01J 19/006; B01J 19/0066; B01J 2219/00166; B01J 2219/00779

(57) ABSTRACT

A turboheating machine for fluid processing includes an outer casing, a rotor, a first energy imparting stage comprising a bladed impeller disk disposed coupled to the shaft, receiving a process fluid and increasing a first amount of kinetic energy of the process fluid in a energy imparting step, a diffuser for converting the kinetic energy imparted to the process fluid in the energy imparting stage into heat energy sufficient to initiate a desired chemical reaction in the process fluid, and a reaction zone disposed downstream of the diffuser for receiving the process fluid discharged from the diffuser, where the first reaction zone is sized and configured to continue the chemical reaction in the process fluid to a predetermined extent and discharging the process fluid at the outlet.

This application claims priority to U.S. provisional application No. 63/440,564, filed on Jan. 23, 2023.

### BACKGROUND

Disclosed embodiments relate generally to the field of turbomachinery, and, more particularly, to turbomachinery arranged to impart thermal energy to a process fluid, such as for carrying out an endothermic process in connection with the process fluid, and, even more particularly, to supersonic diffusers adapted for use in such turbomachinery.

An endothermic process refers to a thermochemical process that involves addition of heat to the fluid to promote occurrence of endothermic reactions. The endothermic process may be used in connection with various industrial operations for fractioning or “cracking” of molecules that may be constituents of the process fluid. Thermal cracking may involve separation of chemical bonds of relatively complex molecular species to form simpler molecular species.

### BRIEF SUMMARY

This invention relates to components designed to facilitate chemical reactions in internal flows of turboheating machines. In one aspect, a turboheating machine for fluid processing includes an outer casing includes a flow inlet for intaking a process fluid and a flow outlet for discharging the process fluid, where a flow path is defined within and separate from the casing extending axially between the flow inlet and the flow outlet, a rotary shaft extending into the casing, where the rotor shaft is driven by a driver, a first energy imparting stage includes a first impeller disk coupled to the shaft, the first impeller disk includes plurality of rotating blades circumferentially disposed around a periphery of the first impeller disk and extending radially outwardly from the first impeller disk into the flow path for increasing a first amount of kinetic energy of the process fluid in a first energy imparting step, a first diffuser disposed downstream of the energy imparting stage, where the diffuser section includes an upstream turning vane zone, a midstream shock zone, and a downstream diffusion zone, for converting the kinetic energy imparted to the process fluid in the energy imparting stage into heat energy sufficient to initiate a desired chemical reaction in the process fluid, and a first reaction zone disposed downstream of the first diffuser for receiving the process fluid discharged from the first diffuser, where the first reaction zone is sized and configured to continue the chemical reaction in the process fluid to a predetermined extent and discharging the process fluid at the outlet.

### BRIEF DESCRIPTION OF THE SEVERAL VIEWS OF THE DRAWINGS

To easily identify the discussion of any particular element or act, the most significant digit or digits in a reference number refer to the figure number in which that element is first introduced.

FIG. 1 illustrates an aspect of the subject matter in accordance with one embodiment.

FIG. 2 illustrates an aspect of the subject matter in accordance with one embodiment.

FIG. 3 illustrates an aspect of the subject matter in accordance with one embodiment.

FIG. 4 illustrates an aspect of the subject matter in accordance with one embodiment.

FIG. 5 illustrates an aspect of the subject matter in accordance with one embodiment.

FIG. 6 illustrates an aspect of the subject matter in accordance with one embodiment.

FIG. 7 illustrates an aspect of the subject matter in accordance with one embodiment.

FIG. 8 illustrates an aspect of the subject matter in accordance with one embodiment.

FIG. 9 illustrates an aspect of the subject matter in accordance with one embodiment.

FIG. 10 illustrates an aspect of the subject matter in accordance with one embodiment.

### DETAILED DESCRIPTION

Before disclosed embodiments are explained in detail, it is to be understood that disclosed embodiments are not limited in applicability to the details of construction and the arrangement of components set forth in this description or illustrated in the following drawings. The underlying principles embodied in disclosed embodiments may be realized by way of further embodiments and of being practiced or of being carried out in various ways. Also, it is to be understood that the phraseology and terminology used herein is for the purpose of description and should not be regarded as limiting.

Various technologies that pertain to apparatuses and/or methodologies will now be described with reference to the drawings, where like reference numerals represent like elements throughout. The drawings discussed below, and the various embodiments used to describe the principles of the present disclosure in this patent document are by way of illustration only and should not be construed in any way to limit the scope of the disclosure. Those skilled in the art will understand that the principles of the present disclosure may be implemented in any suitably arranged apparatus. It is to be understood that functionality that is described as being carried out by certain elements may be performed by multiple elements. Similarly, for instance, an element may be configured to perform functionality that is described as being carried out by multiple elements. The numerous innovative teachings of the present application will be described with reference to exemplary non-limiting embodiments.

It should be understood that the words or phrases used herein should be construed broadly, unless expressly limited in some examples. For example, the terms “including,” “having,” and “comprising,” as well as derivatives thereof, mean inclusion without limitation. The singular forms “a”, “an” and “the” are intended to include the plural forms as well, unless the context clearly indicates otherwise. Further, the term “and/or” as used herein refers to and encompasses any and all possible combinations of one or more of the associated listed items. The term “or” is inclusive, meaning and/or, unless the context clearly indicates otherwise. The phrases “associated with” and “associated therewith,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, or the like. Furthermore, while multiple embodiments or constructions may be described herein, any features, methods, steps, components, etc. described with regard to one embodiment are equally applicable to other embodiments absent a specific statement to the contrary.

Also, although the terms “first”, “second”, “third” and so forth may be used herein to refer to various elements, information, functions, or acts, these elements, information, functions, or acts should not be limited by these terms. Rather these numeral adjectives are used to distinguish different elements, information, functions or acts from each other. For example, a first element, information, function, or act could be termed a second element, information, function, or act, and, similarly, a second element, information, function, or act could be termed a first element, information, function, or act, without departing from the scope of the present disclosure.

In addition, the term “adjacent to” may mean that an element is relatively near to but not in contact with a further element or that the element is in contact with a further portion, unless the context clearly indicates otherwise. Further, the phrase “based on” is intended to mean “based, at least in part, on” unless explicitly stated otherwise. Terms “about” or “substantially” or like terms are intended to cover variations in a value that are within normal industry manufacturing tolerances for that dimension. If no industry standard is available, a variation of twenty percent would fall within the meaning of these terms unless otherwise stated.

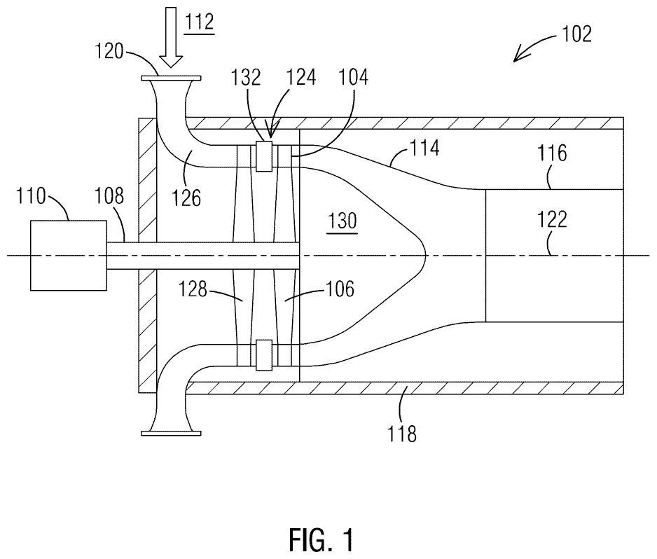

FIG. 1 is a schematic representation of one non-limiting embodiment of a turboheating machine 102 arranged to impart thermal energy to a process fluid 112 directed along a flow path 126. The turboheating machine 102 includes an outer casing 118, such as a pressurized casing, housing the components of the turboheating machine 102 aligned along a central axis 130

A number of blades 104 are circumferentially mounted around a periphery of a rotor impeller disk 106, that in turn is coupled to a shaft 108 driven by a shaft-rotating power source or driver 110, such as an electric motor, steam or gas turbine, or another turbomachine. The blades 104 of the rotor impeller disk 106 impart kinetic energy to the process fluid introduced at an inlet 120 through a well-understood momentum transfer process including accelerating a fluid 112 to a supersonic velocity and then rapidly decelerating the fluid 112. This process converts kinetic energy in the fluid 112 to thermal energy, which can then be used for heating or to perform chemical reactions in the process fluid 112, such as cracking hydrocarbons in natural gas stream. In the example embodiment of FIG. 1, two or more impeller disks, such as impeller disk 106 and impeller disk 130 form an energy imparting stage 126 for adding kinetic energy to the process fluid 112. In one aspect, a row of static turning vanes 138 may be interposed between the impeller disk 106, 128 for directing the process fluid 112 discharged from the upstream impeller disk 106 into the downstream impeller disk 130. It will be appreciated that the number of rows of impeller disks 106, 128 shown in FIG. 1 should be understood as an example and not as a limitation since such number can be adapted based on the needs of any given application. The process fluid 112 is then fluidly coupled to a supersonic diffuser 114 to decelerate the fluid 112 and convert kinetic energy in the process fluid 112 into thermal energy, as described in greater detail below. Unlike other designs that impart kinetic energy to a process fluid 112 and then decelerate that fluid 112 in the same stage, two or more impellers 106 advantageously provide a sequential build up of kinetic energy imparted to the process fluid 112, such as in a first energy imparting step, followed by a second energy imparting step before the additive kinetic energy of the sequential energy imparting steps are finally converted to thermal energy in the downstream diffuser 114. The diffuser 114 is fluidically coupled to a downstream reaction zone 116 configured to condition the heated process fluid 112, for example, to generate a desired chemical reaction in the process fluid 112, such as by controlling the residence time of the heated process fluid 112 in the reaction zone 116. Residence time may be controlled by configuring one a more geometrical features of the reaction zone 116 to provide a desired chemical reaction. The process fluid 112 is then discharged at an outlet 122 of the turboheating machine 102

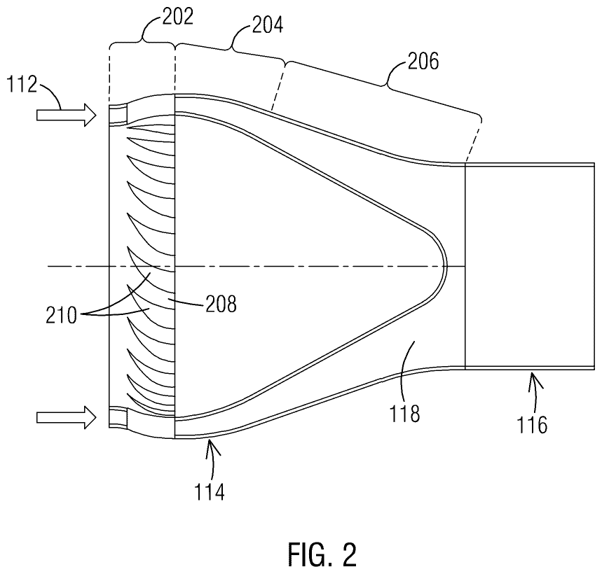

FIG. 2 depicts an embodiment of a supersonic diffuser 114 fluidly coupled to receive process fluid 112 exiting from the most downstream row of rotatable blades 104. Supersonic diffuser 114 includes a turning vane zone 202, a shock zone 204, and a diffusion zone 206. Turning vane zone 202 is configured to define a passageway 208 having a flow area to pass the flow of the process fluid 112 at supersonic velocity between turning vanes 210. In this embodiment, the transition between turning vane zone 202 and shock zone 204 is configured to define a step-change to the flow area of the passageway 208 at a location where the flow of the process fluid 112 exits the turning vane zone 202. It will be understood that turning vane zone 202 is formed by a series of circumferentially arranged individual flow passageways 208 leading to the shock zone 204. That is, shock zone 204 is located downstream from turning vane zone 202. The sudden increase to the flow area this interface leads to a formation of a system of shock waves within the shock zone 204 that in turn increases the static temperature of the process fluid. That is, the step-change to the flow area constitutes a specific, discontinuous change in flow area at the interface between turning vane zone 202 and shock zone 204 to initiate the shock wave system. In general, the transition between turning vane zone 202 and shock zone 204 is defined by the step-change to the flow area and then shock zone 204 may or may not continue with defined circumferentially arrayed passages. Leaving the shock zone 204, the fluid 112 enters the diffusion zone 206 of the diffuser 114 where the fluid 112 is conducted at subsonic speed, further reduced in velocity, and allowed to homogenize. In certain embodiments, the diffusion zone 206 comprises a geometry of net divergent area to efficiently realize pressure recovery in the diffuser 114 of the fluid 112 when entering the downstream reaction zone 116.

In an example embodiment, the reaction zone 116 may contain a downstream portion of the supersonic diffuser 114 configured, for example, to initiate a desired chemical reaction, with a further section of flow passage to achieve a desired chemical reaction in the fluid 112. For example, in hydrocarbon cracking reactions, the amount of time spent at a cracking temperature must be closely controlled as insufficient time at the cracking temperature may reduce yield of desired products and too much reaction time may contribute to the formation of undesirable reaction species, such as free carbon or coke. In one aspect, the residence time in the reaction zone 116 is controlled to a desired value by specification and control of geometric features, for example, a cross-sectional flow area, a volumetric flowrate of the process fluids, and/or a meridional length of the reaction zone 116, In addition, the reaction zone 116 may be geometrically configured to achieve a desired relatively high uniformity of static temperature and velocity fields throughout the reaction zone 116.

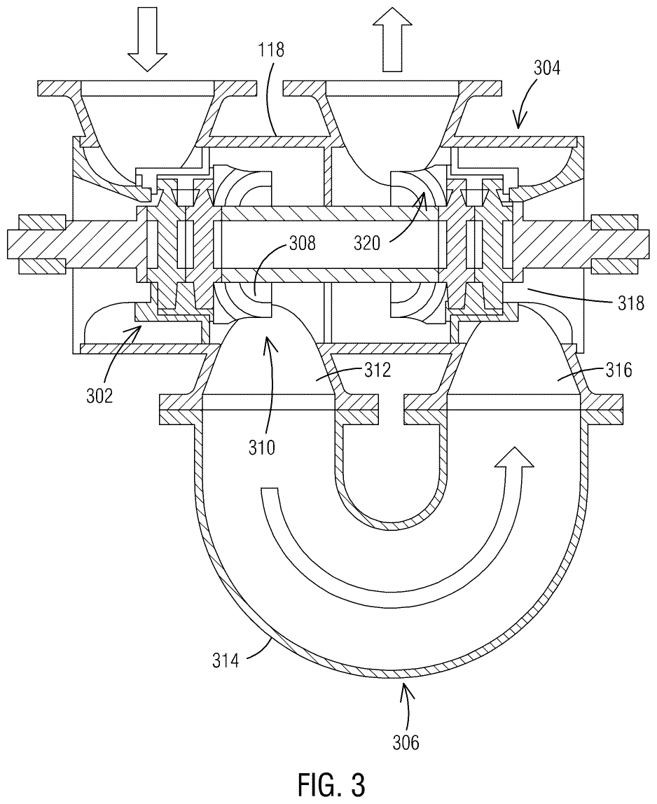

To achieve a desired a chemical reaction in the process fluid 112, multiple kinetic energy to heat energy conversions, or temperature lifts, by one or more turboheating machine stage may be required. As shown in a multistage embodiment in FIG. 3, a first turboheating machine stage 302 and second turboheating machine stage 304 may be housed in a single casing 118. First turboheating machine stage 302 includes a first reaction zone 306 that extends from the first stage diffuser 308 through an axial to radial turn. The first reaction zone 306 is configured to extend though the casing 118, for example, through a first casing penetrating nozzle 312, a casing 118 external flow path such as a section of external piping 314, and back into the casing 118 through a second nozzle 316 at a second stage inlet 318 to the second turboheating machine stage 304. The residence time of this first reaction zone 306 may include all process fluid 112 passages from a downstream section of the first stage diffuser 308 until the inlet region of second stage diffuser 320. A length, and/or other geometric configurations of the external piping 314 may be sized to give the desired optimal residence time.

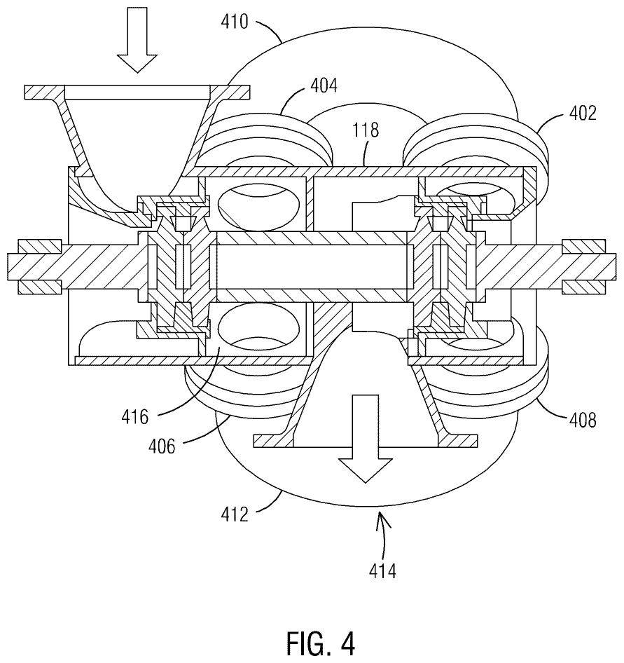

In another multistage embodiment depicted in FIG. 4, multiple external connection nozzle 402, 404, 406, 408 and corresponding transfer piping 410, 412 are included in the reaction zone. For example the transfer piping 410, 412 may be circumferentially distributed around an external periphery of the casing 118 Advantageously, a smaller variation in residence time through the axial to radial exit in respective inlet plenums 416.

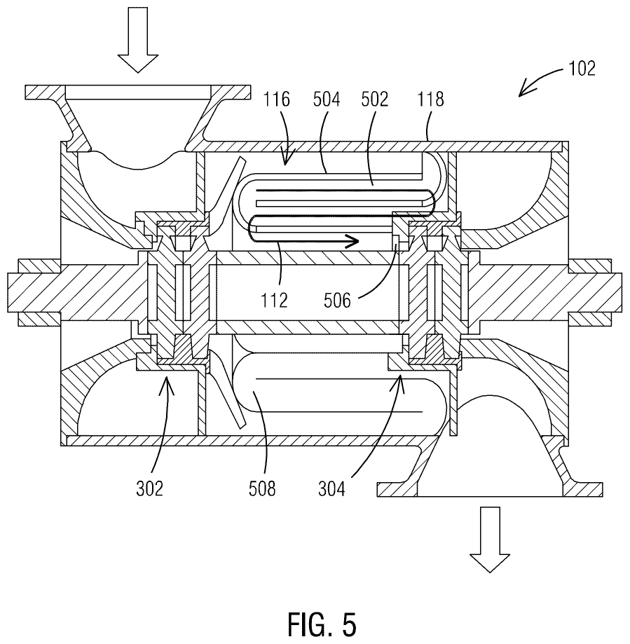

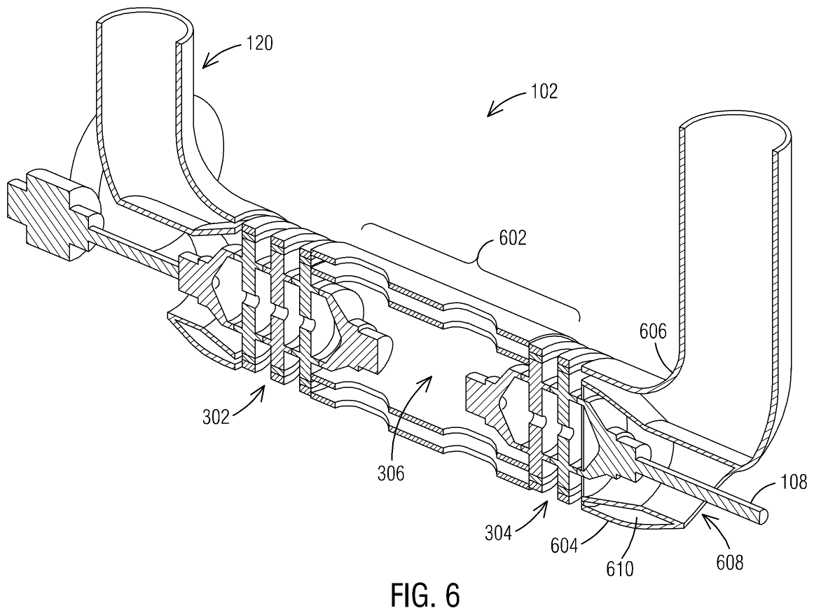

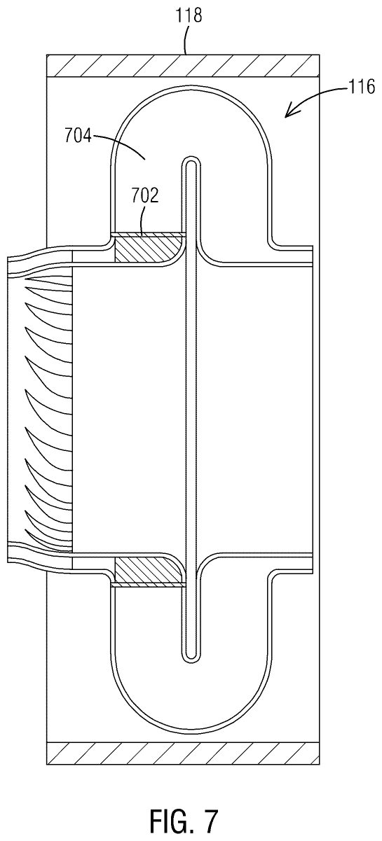

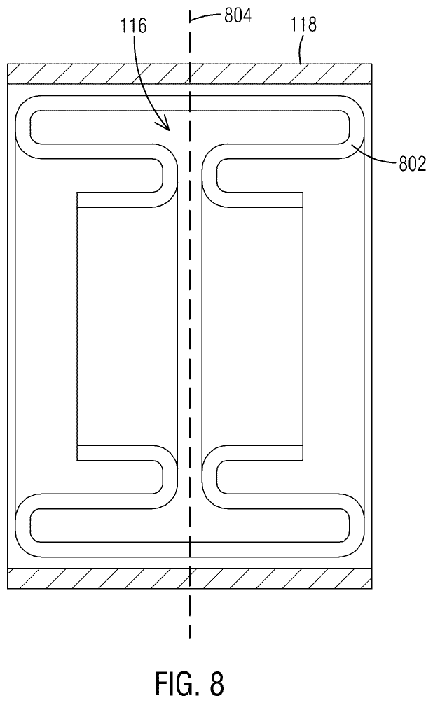

In the embodiments depicted in FIG. 5, FIG. 6, FIG. 7 and FIG. 8, the reaction zone 116 is contained within the turboheating machine 102 casing 118. In the multistage embodiment depicted in FIG. 5, the reaction zone 116 is a series of radially disposed, serpentine axially oriented annular passages 502 where the process fluid 112 is directed back and forth in an axial flow direction between the turboheating machine stages 302, 304 within the casing 118. Flow guides 504, such as cylindrical guides, connected by turning guides 508, such as by toroidal turning guides, may be used to conduct and condition the process fluid 112 flow therethrough. For example, a desired process fluid 112 residence time in the reaction zone 116 may achieved through selection of passage cross sectional area and length. In the multistage embodiment of FIG. 5, the process fluid 112 is conducted through the reaction zones 116 in an axial direction to inlet guide vanes 506 of the second turboheating machine stage 304.

FIG. 6 depicts a multistage turboheating machine 102 embodiment with a straight, axially oriented, annular reaction zone 116 configured between the first turboheating machine stage 302 and the second turboheating machine stage 304. In this embodiment, a volume of the first reaction zone 306 is primarily controlled by varying its axial length 602. To allow for this relatively greater distance between turboheating machine stages, each first turboheating machine stage 302, 304 may be supported on its own rotor system, each rotor system provided with separate drives. In an aspect of this embodiment, the second reaction zone 414 may include an annular section 604 section transitioning to a turning section 606, such as a pipe elbow. The turning section 606 may be configured to include an internal opening 608, such as may be defined by a toroidal portion 610 of the turning section 606 section, to accommodate the rotor shaft 108 passing therethrough to drive the second turboheating machine stage 304. A similar arrangement may be provided at an inlet 120 to the first turboheating machine stage 302 as shown in FIG. 6.

Further embodiments having radially oriented reaction zones 116 are depicted in FIG. 7 and FIG. 8. Advantageously, these embodiments provide a compact radial size of the reaction zone 116 to reduce a need to provide a radially larger casing 118. In the embodiment depicted in FIG. 7. A flow controller 702, such as an annular perforated plate, can be installed in the reaction zone flow path 704 to reduce a velocity of the process fluid 112 flowing therethrough by conditioning the process fluid 112 flow such as by redistributing it in the flow path 704. In an embodiment, the flow controller 702 may include a baffle plate of uniform or non-uniform porosity for redistributing the process fluid 112 evenly in the reaction zone 116. In an aspect, the flow controller 702 may comprise a porous ceramic material or a perforated metallic plate.

In embodiment depicted in FIG. 8, the reaction zone 116 includes multiple turns in a flow turning path 802 disposed primarily in an axial direction to allow reduction of a radial extent of the reaction zone 116, such as an axially oriented serpentine flow turning path 802. In an aspect, the flow turning path 802 may be configured to be axisymmetric about a radial plane 804.

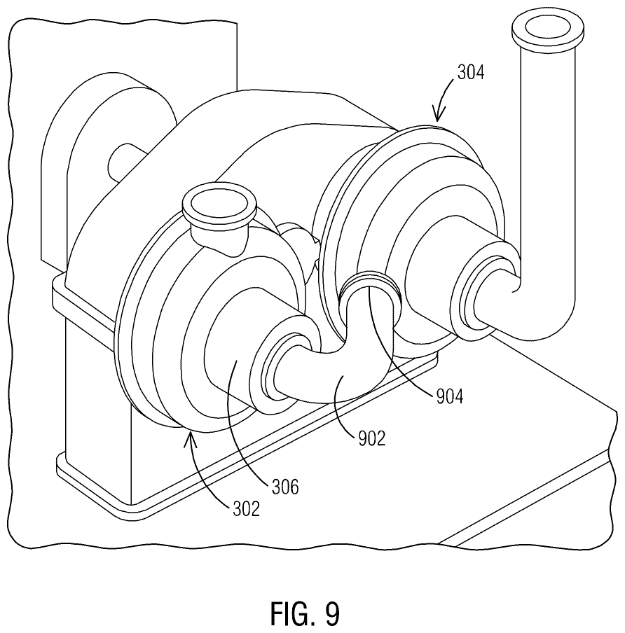

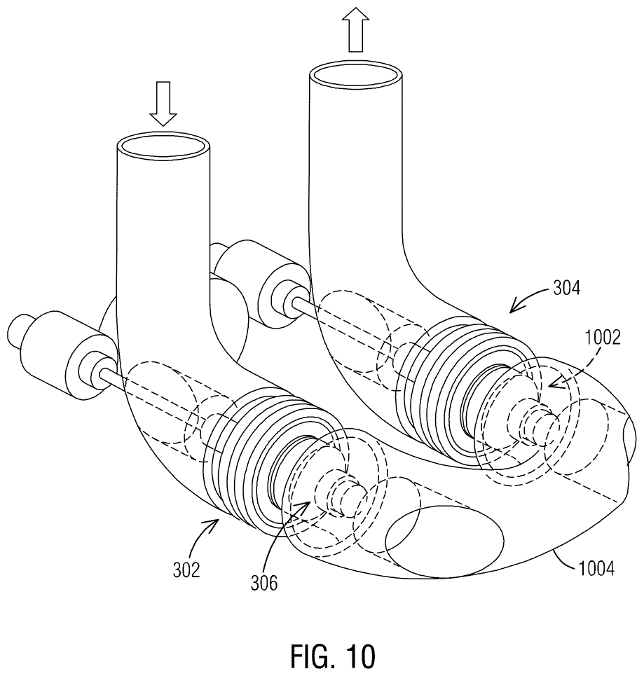

In other embodiments of the present invention depicted in FIG. 9 and FIG. 10, the reaction zone 116 may include an axial discharge path from a first turboheating machine stage 302 into a second turboheating machine stage 304, wherein the first turboheating machine stage 302 and the second turboheating machine stage 304 are not coaxially aligned. As shown in FIG. 9 the reaction zone 116 initially extends in an axial direction and then transitions along a flow path 902 and is directed non-coaxially into an inlet 904 of the second turboheating machine stage 304 stage. The flow path 902 may be geometrically configured, such as its length and cross section, to achieve a desired reaction of the process fluid 112 travelling therethrough.

In the embodiment of FIG. 10, the first reaction zone 306 of the first turboheating machine stage 302 includes an axial discharge from a first turboheating machine stage 302 into a second turboheating machine stage 304 directing the process fluid 112 along a flow path 1004 from the first turboheating machine stage 302 into an axial inlet 1002 of the second turboheating machine stage 304.

Although an exemplary embodiment of the present disclosure has been described in detail, those skilled in the art will understand that various changes, substitutions, variations, and improvements disclosed herein may be made without departing from the spirit and scope of the disclosure in its broadest form.

None of the description in the present application should be read as implying that any particular element, step, act, or function is an essential element, which must be included in the claim scope: the scope of patented subject matter is defined only by the allowed claims. Moreover, none of these claims are intended to invoke a means plus function claim construction unless the exact words “means for” are followed by a participle.

What is claimed is:

1. A turboheating machine for fluid processing comprising:
an outer casing comprising a flow inlet for intaking a process fluid and a flow outlet for discharging the process fluid, wherein a flow path is defined within and separate from the casing extending axially between the flow inlet and the flow outlet;
a rotary shaft extending into the casing, wherein the rotor shaft is driven by a driver;
a first energy imparting stage comprising a first impeller disk coupled to the shaft, the first impeller disk comprising plurality of rotating blades circumferentially disposed around a periphery of the first impeller disk and extending radially outwardly from the first impeller disk into the flow path for increasing a first amount of kinetic energy of the process fluid in a first energy imparting step;
a first diffuser disposed downstream of the energy imparting stage, wherein the diffuser section comprises an upstream turning vane zone, a midstream shock zone, and a downstream diffusion zone, for converting the kinetic energy imparted to the process fluid in the energy imparting stage into heat energy sufficient to initiate a desired chemical reaction in the process fluid, and
a first reaction zone disposed downstream of the first diffuser for receiving the process fluid discharged from the first diffuser, wherein the first reaction zone is sized and configured to continue the chemical reaction in the process fluid to a predetermined extent and discharging the process fluid at the outlet.

2. The turboheating machine of claim 1, wherein the first energy imparting stage comprises a second impeller disk disposed downstream of the first impeller disk for imparting an additional amount of kinetic energy into the process fluid in a second energy adding step prior to entering the diffuser.

3. The turboheating machine of claim 2, wherein the turboheating machine comprises a first turboheating machine stage and second turboheating machine stage disposed downstream of the first turboheating machine stage.

4. The turboheating machine of claim 3, wherein the first reaction zone is disposed between the first turboheating machine stage and the second turboheating machine stage.

5. The turboheating machine of claim 4, wherein the first reaction zone comprises at least one flow path at least partially disposed outside the casing.

6. The turboheating machine of claim 5, wherein the flow path is configured to extend though the casing downstream of the first diffuser through a first casing connection nozzle and back into the casing through a second connection nozzle upstream of the second turboheating machine stage.

7. The turboheating machine of claim 4, wherein the first reaction zone is disposed within the casing.

8. The turboheating machine of claim 7, wherein the first reaction zone comprises a series of radially disposed, serpentine axially-oriented annular passages for directing the process fluid directed back and forth in an axial flow direction of the between the turboheating machine stages.

9. The turboheating machine of claim 8, wherein the radially disposed, serpentine axially-oriented annular passages are defined by cylindrical flow guides connected to toroidal turning guides.

10. The turboheating machine of claim 4, wherein the first turboheating machine stage and the second turboheating machine stage are respectively connected to separate shafts driven by separate drivers.

11. The turboheating machine of claim 7, wherein the reaction zone comprises a radially-oriented, looped flow path.

12. The turboheating machine of claim 11, wherein the flow path comprises a flow controller disposed in at least a portion of the flow path.

13. The turboheating machine of claim 12, wherein the flow controller comprises a baffle plate.

14. The turboheating machine of claim 7, wherein the reaction zone comprises a flow turning path having a plurality of turns disposed primarily in an axial direction.

15. The turboheating machine of claim 7, wherein the flow turning path is configured to be symmetric about a central radial plane of the reaction zone.

16. The turboheating machine of claim 4, further wherein the first reaction zone comprises an axial discharge path extending from the first turboheating machine stage into the second turboheating machine stage, wherein the first turboheating machine stage and the second turboheating machine stage are not coaxially aligned.

17. The turboheating machine of claim 16, wherein the axial discharge path terminates at an axial inlet of the second turboheating machine stage.
